(19) United States
(12) Patent Application Publication
(10) Pub. No.: US 2017/0021862 A1
(43) Pub. Date: Jan. 26, 2017

(54) STEERING WHEEL CONTROL APPARATUS

(71) Applicant: DENSO CORPORATION, Kariya-city (JP)

(72) Inventors: Hisaya Akatsuka, Kariya-city (JP); Toshiki Matsumoto, Kariya-city (JP); Hisashi Iida, Kariya-city (JP)

(21) Appl. No.: 15/213,748

(22) Filed: Jul. 19, 2016

(30) Foreign Application Priority Data
Jul. 21, 2015 (JP) 2015-144035

(51) Int. Cl. B62D 15/02; B60W 30/10; B60W 10/18; B60W 10/20; B60W 50/14

(52) U.S. Cl. CPC B62D 15/025; B60W 10/20; B60W 50/14; B62D 15/0235; B60W 10/18; B60W 30/10; B60W 2050/146; B60W 2510/202; B60W 2520/06; B60W 2710/18; B60W 2710/202

(57) ABSTRACT

A steering wheel control apparatus for controlling driving of a steering wheel of a vehicle includes a steering wheel drive section that drives the steering wheel in accordance with a target value, a shock probability determination section that determines whether the steering wheel may apply a physical shock to a vehicle driver, and a steering wheel driving restriction section that restricts driving of the steering wheel by the steering wheel drive section to reduce the shock applied to the vehicle driver when the shock probability determination section determines that the steering wheel may apply the shock to the vehicle driver.

This application claims priority to Japanese Patent Application No. 2015-144035 filed on Jul. 21, 2015, the entire contents of which are hereby incorporated by reference.

### BACKGROUND OF THE INVENTION

1. Field of the Invention

The present invention relates to a steering wheel control apparatus for controlling driving of a steering wheel of a vehicle.

2. Description of Related Art

There is known a steering wheel control apparatus that controls driving of a steering wheel of a vehicle regardless of a steering operation by a vehicle driver to avoid a collision with an obstacle present ahead of the vehicle. For example, refer to Japanese Patent Application Laid-open No. 2011-162004.

However, this steering wheel control apparatus has a problem in that the vehicle driver touching the steering wheel of the vehicle receives a large physical shock if the steering wheel is driven to be turned greatly.

### SUMMARY

An exemplary embodiment provides a steering wheel control apparatus for controlling driving of a steering wheel of a vehicle, including:

a steering wheel drive section that drives the steering wheel in accordance with a target value;

a shock probability determination section that determines whether the steering wheel may apply a shock to a vehicle driver; and

a steering wheel driving restriction section that restricts driving of the steering wheel by the steering wheel drive section to reduce the shock applied to the vehicle driver when the shock probability determination section determines that the steering wheel may apply the shock to the vehicle driver.

According to the exemplary embodiment, there is provided a steering wheel control apparatus which enables driving a steering wheel safely for a vehicle driver.

Other advantages and features of the invention will become apparent from the following description including the drawings and claims.

### BRIEF DESCRIPTION OF THE DRAWINGS

In the accompanying drawings:

FIG. 1 is a diagram schematically showing the overall structure of an electric steering system of a first embodiment of the invention;

FIG. 2 is a block diagram showing the structurer of an EPS-ECU (Electric Power assisted Steering-ECU) included in the electric steering system;

FIG. 3 is a diagram showing a model of the steering mechanism of the electric steering system;

FIG. 4 is a block diagram showing the entire control system of the electric steering system;

FIG. 5 is a graph showing an advantage provided by the first embodiment;

FIGS. 6A and 6B are picture diagrams for giving a warning to a vehicle driver in the electric steering system of the first embodiment;

FIG. 7 is a block diagram showing the structure of a target tracking control arithmetic section included in the electric steering system of the second embodiment of the invention;

FIGS. 8A and 8B are graphs showing advantages provided by the second embodiment;

FIG. 9 is a block diagram showing the structure of a first modification of the target tracking control arithmetic section included in the electric steering system of the first or second embodiment of the invention;

FIGS. 10A and 10B are graphs showing advantages of the first modification of the target tracking control arithmetic section;

FIG. 11 is a block diagram showing the structure of a second modification of the target tracking control arithmetic section;

FIG. 12 is a block diagram showing the structure of a third modification of the target tracking control arithmetic section;

FIG. 13 is a graph showing an advantage of the third modification of the target tracking control arithmetic section;

FIG. 14 is a diagram showing a model of the steering mechanism in a first modification of a vibration suppression control arithmetic section included in the electric steering system of the first or second embodiment of the invention;

FIG. 15 is a block diagram showing the entire control system of the first modification of the vibration suppression control arithmetic section;

FIG. 16 is a graph showing an advantage of the first modification of the vibration suppression control arithmetic section;

FIG. 17 is a block diagram showing the entire control system of a second modification of the vibration suppression control arithmetic section;

FIG. 18 is a graph showing an advantage of the second modification of the vibration suppression control arithmetic section;

FIG. 19 is a block diagram showing the entire control system of a third modification of the vibration suppression control arithmetic section;

FIG. 20 is a graph showing an advantage of the third modification of the vibration suppression control arithmetic section;

FIG. 21 is a block diagram showing the entire control system of a fourth modification of the vibration suppression control arithmetic section;

FIG. 22 is a graph showing an advantage of the fourth modification of the vibration suppression control arithmetic section;

FIG. 23 is a diagram schematically showing the overall structure of a modification of the electric steering system of the first or second embodiment of the invention;

FIGS. 24A and 24B are diagrams showing a first example of a picture diagram for giving a warning to the vehicle driver in the modification of the electric steering system;

FIGS. 25A and 25B are diagrams showing a second example of a picture diagram for giving a warning to the vehicle driver in the modification of the electric steering system; and

FIG. 26 is a block diagram showing the structure of the modification of the electrical steering system provided with an variable gear ratio steering actuator.

### PREFERRED EMBODIMENTS OF THE INVENTION

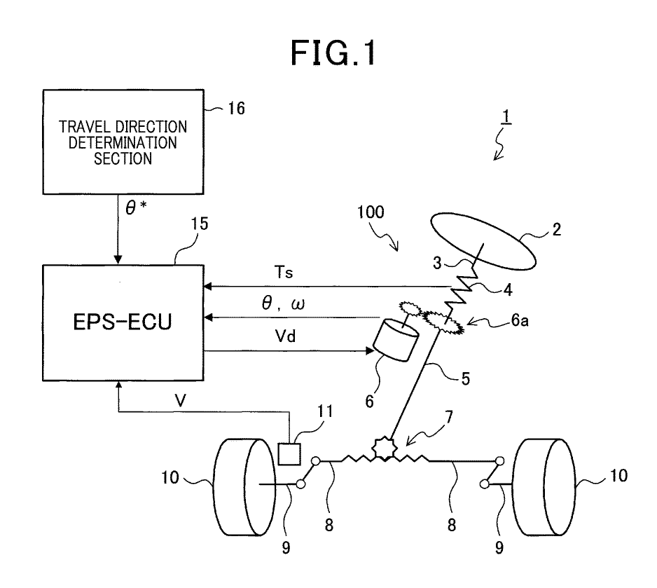

FIG. 1 is a diagram schematically showing the overall structure of an electric steering system 1 of a first embodiment of the invention.

As shown in FIG. 1, the electric steering system 1 includes a steering wheel 2, a steering shaft 3, a torque sensor 4, an intermediate shaft 5, a motor 6, a steering gear box 7, tie rods 8, knuckle arms 9, and tires 10. The electric steering system 1 also includes an EPS-ECU (Electrical Power Steering ECU) 15 and a travel direction determination section 16.

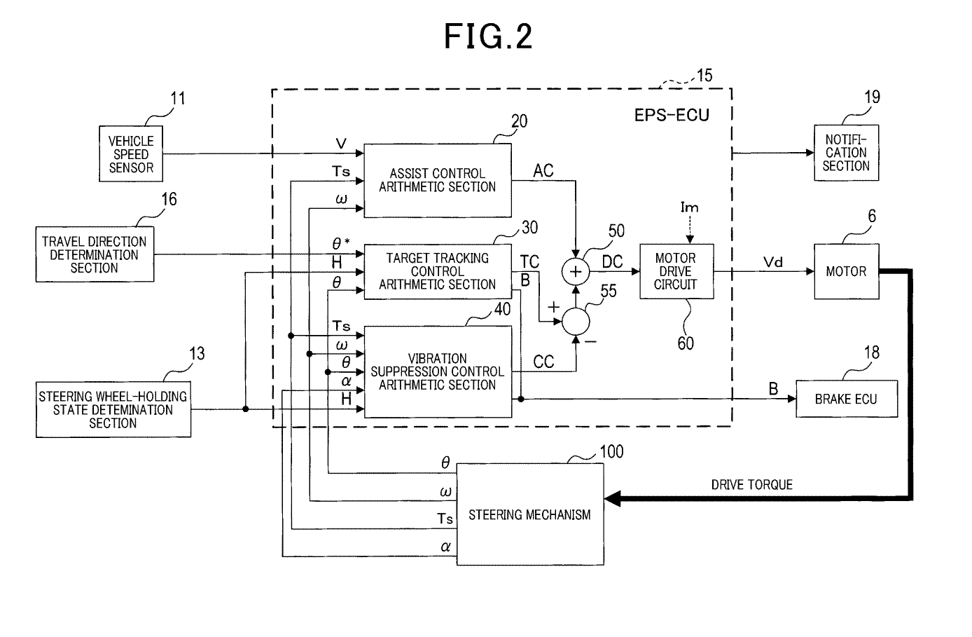

Further, as shown in FIG. 2, the electric steering system 1 includes a steering wheel-holding state determination section 13, a brake ECU 18 and a notification section 19. The steering wheel 2 is fixed to a first end of the steering shaft 3 whose second end is connected with a first end of the torque sensor 4. The torque sensor 4 is connected with the intermediate shaft 5 at its second end. In the following, the whole of the shaft body extending from the steering shaft 3 to the intermediate shaft 5 through the torque sensor 4 may be referred to as the steering shaft.

The torque sensor 4 is for detecting a steering torque Ts. The torque sensor 4 includes a torsion bar which connects the steering shaft 5 and the intermediate shaft 5 to each other to detect the torque applied to the torsion bar as the steering torque Ts based on the torsion angle of the torsion bar.

The motor 6 is for generating an assist torque in accordance with assist control and generating an automatic steering torque in accordance with target tracking control. The rotation of the shaft of the motor 6 is transmitted to the intermediate shaft 5 through a reduction gear device 6a. The reduction gear device 6a includes a worm gear disposed at the front end of the shaft of the motor 6 and a worm wheel disposed coaxially with the intermediate shaft 6 in a state of being engaged with the worm gear.

The rotation of the motor 6 is transmitted to the intermediate shaft 5. On the other hand, when the intermediate shaft 5 is rotated due to an operation of the steering wheel 2 or a reaction force from the road surface (road surface reaction force), this rotation is transmitted to the shaft of the motor 6 through the reduction gear device 6a causing the motor 6 to rotate.

In this embodiment, the motor 6 is a brushless motor provided with a rotation sensor such as a resolver. The rotation sensor outputs a motor state signal including at least a motor rotation angle θ, a motor rotation angular velocity ω and a motor rotation angular acceleration α. Alternatively, instead of the motor state signal, there may be used a steering angle, a steering angular velocity and a steering angular acceleration which can be obtained by multiplying the motor rotation angle θ, the motor rotation angular velocity ω and the motor rotation angular acceleration α with the gear ratio of the reduction gear device 6a. Further, a tire steering angle showing the steering angle of the tire relative to a reference angle (relative to the front direction of the vehicle, for example), a tire steering angular velocity and a tire steering angular acceleration may be used instead of the motor state signal.

The intermediate shaft 5 is connected to the torque sensor 4 at its first end, and connected to a steering gear box 7 at its second end. The steering gear box 7 includes a gear mechanism constituted of a rack and a pinion gear. The rack is engaged with the pinion gear disposed at the second end of the intermediate shaft 5. Accordingly, when the vehicle driver turns the steering wheel 2, the intermediate shaft 5 and the pinion gear rotate, causing the rack to move horizontally. The rack is fitted with the tie rods 8 at both ends. Accordingly, the tie rods 8 move horizontally together with the rack. As a result, since the tie rods 8 pull or push the knuckle arms 9, the directions of the steering tires are changed.

The vehicle is provided with a vehicle speed sensor 11 to detect the vehicle speed V. In the following, the whole of the mechanism which transmits the steering force of the steering wheel 2 to the tires 10 may be referred to as the steering mechanism 100.

In the steering mechanism 100 having the structure described above, when the steering wheel 2 is rotated by the vehicle driver, the rotation of the steering wheel 2 is transmitted to the steering gear box 7 through the steering shaft 3, the torque sensor 4, and the intermediate shaft 5. The rotation of the intermediate shaft 5 is converted into a horizontal movement of the tie rods 8 within the steering gear box 7. The horizontal movement of the tie rods 8 causes the tires 10 to be steered.

The steering wheel-holding state determination section 13 determines whether the vehicle driver is in a position around the steering wheel 2 where the vehicle driver may receive a physical shock due to steering of the vehicle. In this embodiment, a pressure sensor is fitted to the steering wheel 2 to detect whether the vehicle driver is holding the steering wheel 2. The steering wheel-holding state determination section 13 determines whether the vehicle driver is around the steering wheel 2 based on the output of the pressure sensor.

Instead of the pressure sensor, there may be provided a camera or an infrared sensor for detecting whether the vehicle driver is touching the steering wheel 2 or inserting a hand inside the steering wheel 2, or a torque sensor for detecting the torque applied to the steering wheel 2 by the vehicle driver.

The travel direction determination section 16, which operates on electric power supplied from a vehicle battery (not shown), detects a travelling lane and the position of the vehicle in the travelling lane from images imaged by a vehicle-mounted camera (not shown) and sets a target course based on the detection results. Further, the travel direction determination section 16 sets a controlled variable used for the vehicle to run along the target course.

In this embodiment, a target angle θ* which is a target value of the steering angle (or the motor rotation angle) is set as the controlled variable, and is outputted to the EPS-ECU 15. Since setting such a target angle in lane keep control is well known, detailed explanation thereof is omitted here.

The EPS-ECU 15, which operates on electric power supplied from the vehicle battery, calculates a definitive command DC based on the target angle θ* determined by the travel direction determination section 16, the steering torque detected by the torque sensor 4, the motor rotation angle θ, motor rotation angular velocity ω and motor rotation angular acceleration α which are sent from the motor 6, and the vehicle speed V detected by the vehicle speed sensor 11.

The definitive command DC is the sum of an assist command AC which is an electric current command value to generate the assist torque, the tracking control command TC which is an electric current command value to generate an automatic steering torque, and an compensation command CC which is an electric current command value to suppress vibration. In this embodiment, the compensation command CC includes a component for restricting the driving of the steering wheel 2 to reduce a shock applied to the vehicle driver when the steering wheel 2 is driven to rotate. By applying a drive voltage Vd in accordance with the definitive command DC to the motor 6, the assist torque and the automatic steering torque are generated.

That is, the EPS-ECU 15 controls the steering characteristics by controlling the motor 6 using the driver voltage Vd to thereby control the steering mechanism 100 which is driven by the motor 6.

The brake ECU 18 has a function as an electronic control unit for controlling braking of the vehicle. The brake ECU 18 complements the restricted steering force of the steering wheel 2 using a brake actuator (not shown) which functions as a driving section other than a later-explained target tracking control arithmetic section 30.

This is because, when the EPS-ECU 15 restricts the steering force by reducing the calculated controlled variable to enable the vehicle to travel along a target course for the purpose of reducing a shock applied to the vehicle driver, there is a risk that the vehicle cannot travel along the target course due to inadequacy of the steering force. Hence, the brake ECU 18 controls so as to compensate for shortage of the steering force by causing only some of the wheels to be applied with a braking force when the EPS-ECU 15 restricts the steering force.

FIG. 2 is a block diagram showing the overall structurer of the EPS-ECU 15. As shown in FIG. 2, the EPS-ECU 15 includes an assist control arithmetic section 20, the target tracking control arithmetic section 30, a vibration suppression control arithmetic section 40, an adder 50, a subtractor 55 and a motor driver circuit 60. The assist control arithmetic section 20 generates the assist command AC.

The target tracking control arithmetic section 30 generates the tracking command TC. The vibration suppression control arithmetic section 40 generates the compensation command CC. The subtractor 55 generates a compensated version of the tracking command TC by subtracting the compensation command CC from the tracking command TC. The adder generates, as a drive command DC, an electric current command value for driving the motor 6 by adding the assist command AC to the compensated version of the tracking command TC.

The motor drive circuit 60 drives the motor 6 by applying the drive voltage Vd (which is a three-phase voltage when the motor 6 is a three-phase motor) to the motor 6 in accordance with the drive command DC. The functions of the assist control arithmetic section 20, the target tracking control arithmetic section 30, the vibration suppression control arithmetic section 40, the adder 50 and the subtractor 55 may be implemented by control programs executed by a CPU (not shown) included in the EPS-ECU 15.

In this case, the control programs are executed at a given period to ensure a necessary responsiveness of the target tracking control (lane keeping control). The period may be set in a range between several hundreds of μs and several hundreds of ms.

The EPS-ECU 15 is configured to update the drive command DC at this period. Alternatively, at least part of these functions may be implemented by a hardware device such as a logic circuit.

The motor drive circuit 60 applies the drive voltage Vd to the motor 6 in accordance with the drive command DC so that the assist torque and the automatic steering torque corresponding to the drive command DC are applied to the steering shaft. Specifically, the steering shaft is caused to generate a desired torque by feedback-controlling the drive voltage Vd such that a current Im flowing through the motor 6 becomes equal to a target current. Since the structure of such a motor drive circuit is well known (refer to Japanese Patent Application laid-open No. 2013-52793, for example), detailed explanation is omitted here.

The assist control arithmetic section 20 generates the assist command AC based on the steering torque Ts, the motor rotation angular velocity ω, and the vehicle speed V. The assist command AC is a torque to assist operation of the steering wheel 2 so as to realize a feel reflecting the road surface reaction force and the steering state.

Specifically, the assist control arithmetic section 20 calculates a base assist amount to obtain a feeling of torque transmission in accordance with the road surface reaction force based on the steering torque Ts and the vehicle speed V, calculates an assist compensation amount in accordance with the steering state depending on the steering torque Ts and the motor rotation angular velocity ω, and generates the assist command AC by multiplying the assist compensation amount with a gain depending on the vehicle speed V. The procedure of calculating the assist command AC is not limited to the one described above, and any other known procedure may be used.

The target tracking control arithmetic section 30 generates the tracking command TC based on the target angle θ*, the steering angle (or motor rotation angle) θ. The steering angle θ may be referred to as the actual angle θ hereinafter. The tracking command TC is an electric current command value for generating the automatic steering torque necessary to cause the actual angle θ to follow the target angle θ*.

In this embodiment, the target tracking control arithmetic section 30 obtains a deviation Δθ (=θ*−θ) between the actual angle θ and the target angle θ*, and defines a control characteristic by imparting a PID gain to this deviation Δθ. The target tracking control arithmetic section 30 outputs the tracking command TC depending on the control characteristic.

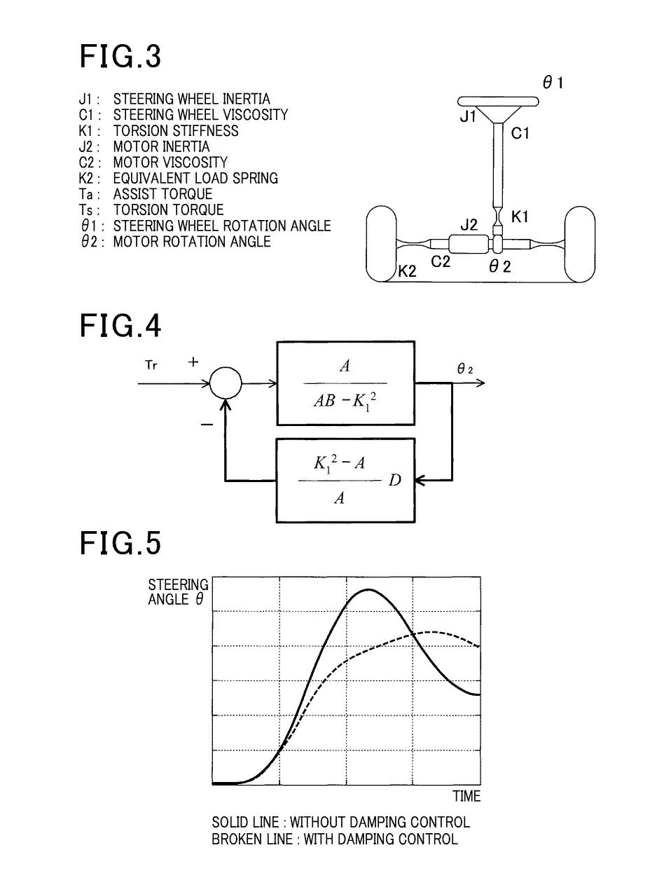

The tracking command TC is set such that the responsiveness of the target tracking control increases with the increase of the PID gain and decreases with the decreases of the PID gain. The vibration suppression control arithmetic section 40 calculates a controlled variable used for suppressing a steering vibration due to steering mechanism oscillation of the steering mechanism 100, and outputs it as the compensation command CC. More specifically, in this embodiment, a motion equation is obtained from a model of the steering mechanism as shown in FIG. 3, and a damping control amount is set based on this motion equation.

The motion equation is given as follows.

$$\{ \begin{matrix}{J}_{1} {s}^{2} {θ}_{1} + {C}_{2} s {θ}_{1} + {K}_{1} ( {θ}_{1} - {θ}_{2} ) = 0 \\ {J}_{2} {s}^{2} {θ}_{2} + {C}_{2} s {θ}_{2} + {K}_{2} {θ}_{2} - {K}_{1} ( {θ}_{1} - {θ}_{2} ) = {T}_{a} \\ {K}_{1} ( {θ}_{1} - {θ}_{2} ) = {T}_{s}\end{matrix} \qquad Equation ( 1 )$$

The transfer function based on this motion equation is given by the following Equation (2).

$${θ}_{1} = \frac{{K}_{1}}{{J}_{1} {s}^{2} + {C}_{1} s + {K}_{1}} {θ}_{2} = \frac{{K}_{1}}{A} {θ}_{2} \\ A = {J}_{1} {s}^{2} + {C}_{1} s + {K}_{1} \\ {T}_{a} = ( {J}_{2} {s}^{2} + {C}_{2} s + {K}_{1} + {K}_{2} ) {θ}_{2} - \frac{{K}_{1}}{A} {θ}_{2} = ( B - \frac{{K}_{1}}{A} ) {θ}_{2} \\ B = {J}_{2} {s}^{2} + {C}_{2} s + {K}_{1} + {K}_{2} \\ \frac{{θ}_{2}}{{T}_{a}} = \frac{A}{AB - {K}_{1}^{2}} \qquad Equation ( 2 )$$

When the damping control amount is D, the whole of the control system of the EPS-ECU 15 can be shown by the block diagram of FIG. 4. The input-output relationship of this control system is given by the following Equation (3).

$${T}_{s} = {K}_{1} ( {θ}_{1} - {θ}_{2} ) = {K}_{1} ( \frac{{K}_{1}}{A} {θ}_{2} - {θ}_{2} ) = \frac{{K}_{1}^{2} - A}{A} {θ}_{2} \\ {θ}_{2} = \frac{A}{AB - {K}_{1}^{2}} ( {T}_{r} - \frac{{K}_{1}^{2} - A}{A} D {θ}_{2} ) \\ \frac{{θ}_{2}}{{T}_{r}} = \frac{\frac{A}{AB - {K}_{1}^{2}}}{1 + \frac{A}{AB - {K}_{1}^{2}} \frac{{K}_{1}^{2} - A}{A} D} = \frac{\frac{A}{AB - {K}_{1}^{2}}}{1 + \frac{{K}_{1}^{2} - A}{AB - {K}_{1}^{2}} D} = \frac{A}{AB - {K}_{1}^{2} + ( {K}_{1}^{2} - A ) D} = \frac{A}{A ( B - D ) - {K}_{1}^{2} + {K}_{1}^{2} D} \qquad Equation ( 3 )$$

By appropriately setting the value of the term (K₁²−A)D/A in FIG. 4, vibration of the steering wheel 2 can be suppressed. The value of θ₂/Tr in equation (3) is set smaller while the steering wheel-holding state determination section 13 detects a presence of the body of the vehicle driver around the steering wheel 2 than while it does not. By this setting, suppression control to prevent the steering wheel 2 from being driven to turn rapidly can be implemented.

In this embodiment, the value of D is set larger while the steering wheel-holding state determination section 13 detects a presence of the body of the vehicle driver around the steering wheel 2 than while it does not. As a result, as shown in FIG. 5, the amount of change of the steering angle becomes smaller when the suppression control is performed (see the broken line) than when the suppression control is not performed (see the solid line).

When the EPS-ECU 15 performs the suppression control to suppress the driving of the steering wheel 2, the EPS-ECU 15 sends a command showing the content of the suppression control to the notification section 19. In response to this command, the notification section 19 notifies the vehicle driver of the content of the suppression control.

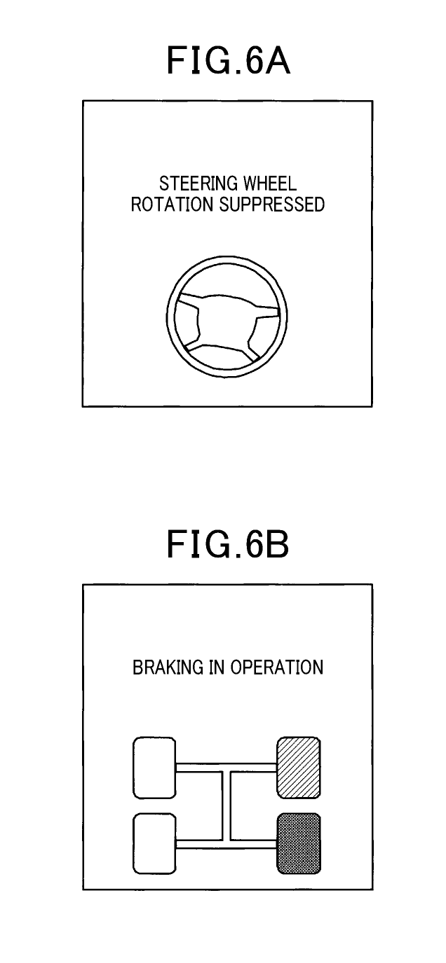

For example, when the suppression control operates to suppress turning of the steering wheel 2, the notification section 19 emits a warning sound, and displays a picture as shown in FIG. 6A near the meter panel of the vehicle. On the other hand, when the suppression control causes the brake ECU 18 to operate, the notification section 19 displays a picture as shown in FIG. 6B.

The electric steering system 1 described above provides the following advantages.

In the electric steering system 1, the target tracking control arithmetic section 30 drives the steering wheel 2 in accordance with the target value. The steering wheel-holding state determination section 13 detects a presence of the body of the vehicle driver around the steering wheel 2. The target tracking control arithmetic section 30 and the vibration suppression control arithmetic section 40 restrict the driving of the steering wheel 2 by the target tracking control arithmetic section 30 to reduce a physical shock applied to the vehicle driver from the steering wheel 2 depending on the position of the body of the vehicle driver.

According to the electric steering system 1, since the driving of the steering wheel 2 is restricted depending on the position of the body of the vehicle driver, it is possible to reduce a physical shock which the steering wheel 2 applies to the vehicle driver so that the steering wheel 2 can be driven safely for the vehicle driver.

In the electric steering system 1, the brake ECU 18 complements the restricted steering force of the steering wheel 2 using the drive section other than the target tracking control arithmetic section 30.

According to the electric steering system. 1, since the brake ECU 18 complements the restricted steering force by causing the drive section other than the target tracking control arithmetic section 30 to operate, it is possible to control the behavior of the vehicle satisfactory even when the operation of the target tracking control arithmetic section 30 is restricted.

In the electric steering system 1, the target tracking control arithmetic section 30 and the vibration suppression control arithmetic section 40 restrict the driving of the steering wheel 2 by the target tracking control arithmetic section 30 by imparting a damping torque to the output of the target tracking control arithmetic section 30.

According to the electrical steering system 1, it is possible to reduce a shock applied to the vehicle driver without modifying the structure of the target tracking control arithmetic section 30.

In the electric steering system 1, the steering wheel-holding state determination section 13 detects whether the vehicle driver is holding the steering wheel 2.

The electric steering system 1 can restrict the driving of the steering wheel 2 while the steering wheel 2 is detected to be held by the vehicle driver.

In the electric steering system 1, the notification section 19 informs the vehicle driver of the states of the target tracking control arithmetic section 30 and the vibration suppression control arithmetic section 40. According to the electric steering system 1, the vehicle driver can perform a driving operation appropriately taking into account the states of the target tracking control arithmetic section 30 and the vibration suppression control arithmetic section 40.

In the electric steering system 1, the target tracking control arithmetic section 30 drives the steering wheel 2 such that the measured value (the actual steering angle θ) approaches the target value (the target angle θ*), and the vibration suppression control arithmetic section 40 suppress the measured value from approaching the target value while the driving of the steering wheel 2 is restricted.

Therefore, since the turning speed of the steering wheel 2 is suppressed while the driving of the steering wheel 2 is restricted, it is possible to drive the vehicle safely.

### Second Embodiment

Next, a second embodiment of the invention is described with a focus on differences with the first embodiment.

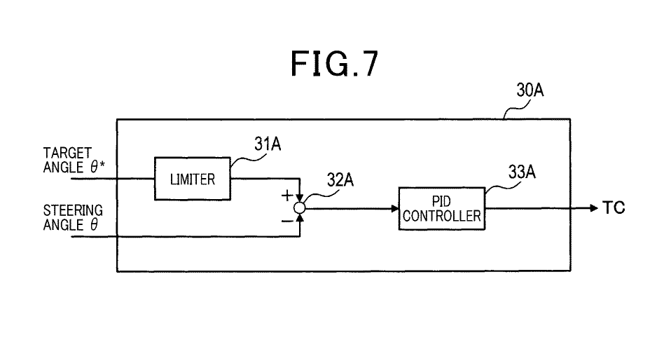

In the first embodiment described above, the driving of the steering wheel 2 is restricted using the compensation command CC outputted from the vibration suppression control arithmetic section 40. Whereas, in the second embodiment, the driving of the steering wheel 2 is restricted using the tracking command TC outputted from the target tracking control arithmetic section 30. More precisely, in the second embodiment, instead of the target tracking control arithmetic section 30, a target tracking control arithmetic section 30A having the structure shown in FIG. 7 is used.

The target tracking control arithmetic section 30A includes a limiter 31A, a subtractor 32A and a PID controller 33A. The limiter 31A has a filter function of restricting the target angle θ*. Specifically, the limiter 31A restricts the upper limit of the target angle θ*, or restricts the rate of change of the target angle θ*.

The subtractor 32A outputs the deviation between the output of the limiter 31A and the actual steering angle θ.

The PID controller 33A generates the PID gain. That is, the PID controller 33A generates a gain for reducing the output of the subtractor 32A, and outputs it as the tracking command TC.

The limiter 31A is used only while the steering wheel-holding state determination section 13 detects a presence of the body of the vehicle driver around the steering wheel 2. In this embodiment, the output of the limiter 31A is set valid while the steering wheel-holding state determination section 13 detects a presence of the body of the vehicle driver around the steering wheel 2, and otherwise set invalid.

Alternatively, the second embodiment may include both the target tracking control arithmetic section 30 and the target tracking control arithmetic section 30A. In this case, the output of the target tracking control arithmetic section 30A is used while the steering wheel-holding state determination section 13 detects a presence of the body of the vehicle driver around the steering wheel 2, and the output of the target tracking control arithmetic section 30 is used while the steering wheel-holding state determination section 13 detects no presence of the body of the vehicle driver around the steering wheel 2.

The second embodiment described above provides the following advantages. The target tracking control arithmetic section 30 suppresses the measured value from approaching the target value to restrict the driving of the steering wheel 2 by restricting the range of the target value or by restricting the rate of change or acceleration of change of the target value.

Therefore, according to the second embodiment, it is possible to set such that the steering wheel 2 is allowed to be driven only within a range in which a shock applied to the vehicle driver is sufficiently small.

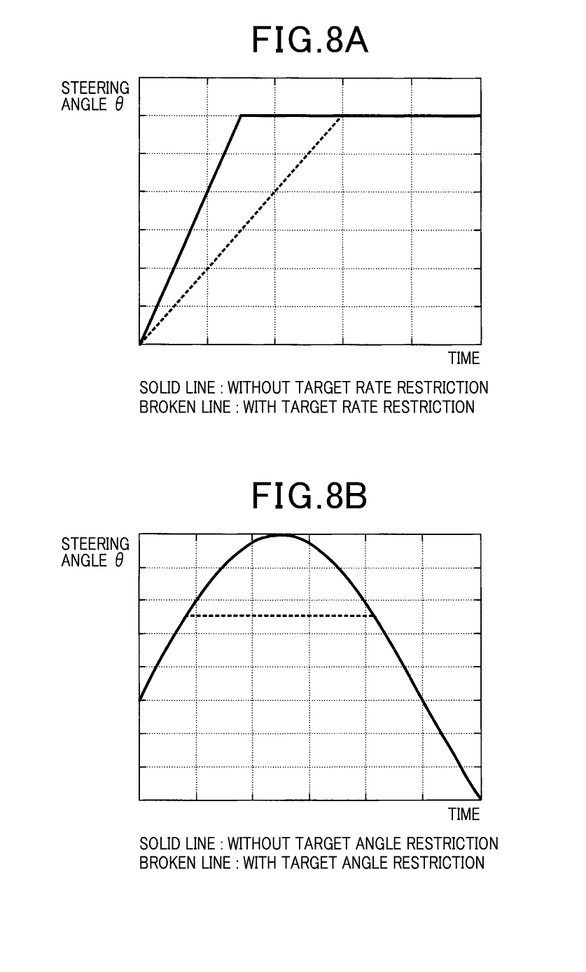

For example, in the configuration where the limiter 31A restricts the rate of change the target angle θ* while the steering wheel-holding state determination section 13 detects a presence of the body of the vehicle driver around the steering wheel 2, the rate of change of the steering angle θ is gentle as shown by the broken line in FIG. 8A compared to that shown by the solid line in FIG. 8A in the case where the limiter 31A is not provided. According to this configuration of the second embodiment, since the rate of change of the steering angle is restricted when the steering wheel 2 is turned to a target position, a shock applied to the vehicle driver can be reduced.

In another configuration where the limiter 31A restricts the upper limit of the target angle θ*, the amount of change of the steering angle θ is limited (see the broken line in FIG. 8B) compared to that in the case where the limiter 31A is not provided (see the solid line in FIG. 8B). According to this configuration of the second embodiment, although the rate of change of the steering angle is not restricted, it is possible to reduce a shock applied to the vehicle driver by setting the upper limit of the target angle θ* depending on the detected position of the body of the vehicle driver such that the steering wheel 2 does not touch the vehicle driver.

### Other Embodiments

The components of the electric steering systems according to the above described embodiments may be implemented by executing computer programs stored in a storage device.

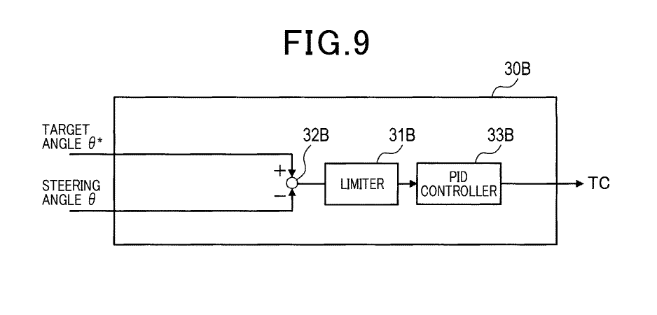

Instead of the target tracking control arithmetic section 30, a target tracking control arithmetic section 30B having the structure shown in FIG. 9 may be used to restrict the driving of the steering wheel 2. As shown in FIG. 9, the target tracking control arithmetic section 30B includes a limiter 30B, a subtractor 32B and a PID controller 33B.

The subtractor 32B outputs a signal indicating the deviation between the target steering angle θ* and the actual steering angle θ. The limiter 31B restricts the upper limit or the rate of change of the output of the subtractor 32B. The limiter 31B is used only when the steering wheel-holding state determination section 13 is detecting a presence of the body of the vehicle driver around the steering wheel 2.

That is, the target tracking control arithmetic section 30B suppresses the measured value from approaching the target value by changing the magnitude of the signal indicating the deviation between the target value and the actual value to a smaller value, or by changing the rate of change or acceleration of change of the target value to a smaller value.

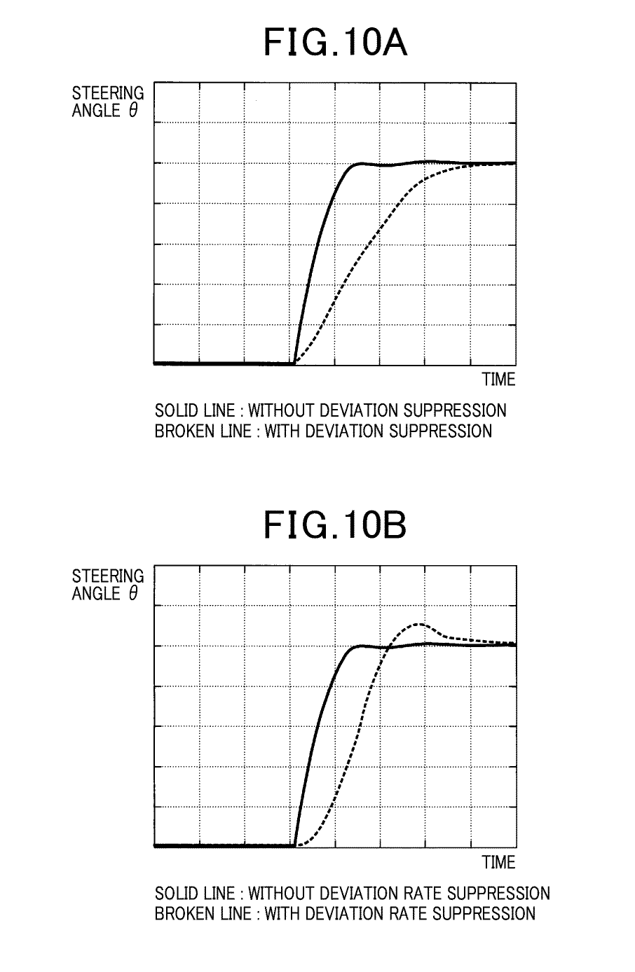

Also by using the target tracking control arithmetic section 30B, it is possible to prevent the steering wheel 2 from being driven to rotate rapidly, to reduce a shock applied to the vehicle driver. The solid lines of FIG. 10A and FIG. 10B show examples of the rate of change of the steering angle θ when the limiter 30B is not used, while the broken lines of FIG. 10A and FIG. 10B show examples of the rate of change of the steering angle θ when the limiter 30B is used.

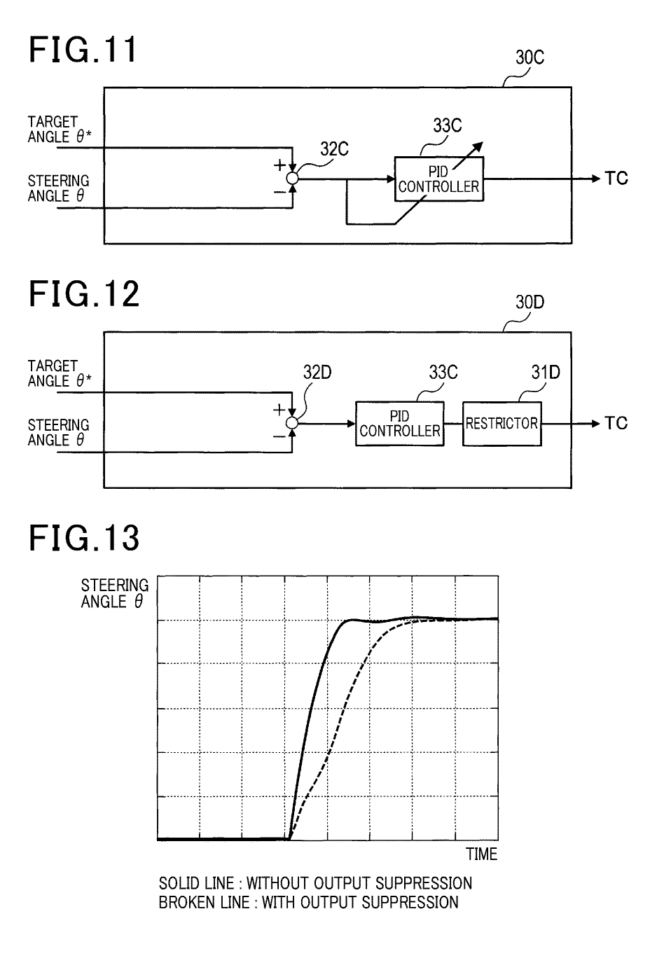

Further, instead of the target tracking control arithmetic section 30, a target tracking control arithmetic section 30C having the structure shown in FIG. 11 may be used. The target tracking control arithmetic section 30C includes a subtractor 32C and a PID controller 33C. The target tracking control arithmetic section 30C does not include a limiter.

The PID controller 33C, which imparts a PID gain to the output of the subtractor 32C, can vary the PID gain in accordance with the output of the steering wheel-holding state determination section 13. Specifically, the PID gain is set smaller while the steering wheel-holding state determination section 13 detects a presence of the body of the vehicle driver around the steering wheel 2 than while it does not.

That is, the target tracking control arithmetic section 30 reduces the responsiveness in causing the measured value to approach the target value to restrict the driving of the steering wheel 2. This makes it possible to suppress the steering wheel 2 from being driven rapidly, to reduce a shock applied to the vehicle driver.

Instead of the target tracking control arithmetic section 30, a target tracking control arithmetic section 30D having the structure shown in FIG. 12 may be used. The target tracking control arithmetic section 30D includes a limiter 31D, a subtractor 32D and a PID controller 33D.

The subtractor 32D outputs a signal indicating the deviation between the target steering angle θ* and the actual steering angle θ. The PID controller 33D imparts a PID gain to the output of the subtractor 32D. The limiter 31D restricts the upper limit or the rate of change of the output of the PID controller 33D. The limiter 31D is used only while the steering wheel-holding state determination section 13 detects a presence of the body of the vehicle driver around the steering wheel 2.

The target tracking control arithmetic section 30 suppresses the measured value from approaching the target value by restricting the controlled variable to restrict the driving of the steering wheel 2.

This makes it possible to suppress the steering wheel 2 from being driven urgently to reduce a shock applied to the vehicle driver. The solid line of FIG. 13 shows an example of the rate of change of the steering angle θ when the limiter 31D is not provided, while the broken line of FIG. 13 shows an example of the rate of change of the steering angle θ when the limiter 31D is used.

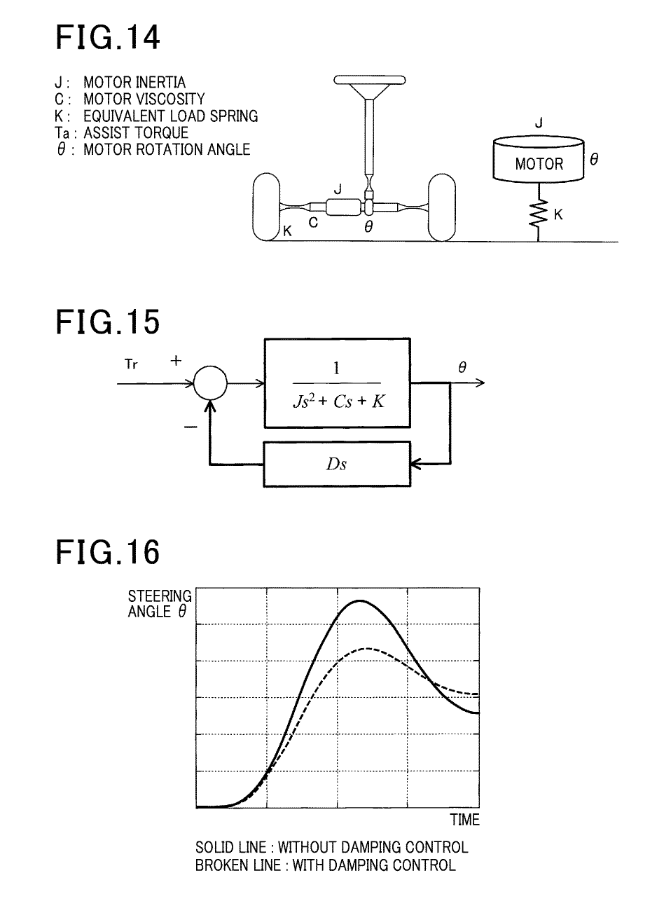

In the first embodiment, the damping using the steering torque Ts is implemented by the vibration suppression control arithmetic section 40. However, it may be implemented using the motor rotation angular velocity co. In this case, a motion equation is obtained from a model of the steering mechanism as shown in FIG. 14, and a damping amount is set based on the motion equation.

The motion equation is given as follows.

Tₐ=Js²θ+Csθ+Kθ=(Js²+Cs+K)θ Equation (4):
The transfer function based on this motion equation is given by the following Equation (5).

$$\frac{θ}{{T}_{a}} = \frac{1}{{Js}^{2} + Cs + K} \qquad Equation ( 5 )$$

When the damping control amount is D, the whole of the control system of the EPS-ECU 15 can be shown by the block diagram of FIG. 15. The input-output relationship of this control system is given by the following Equation (6).

$$θ = \frac{1}{{Js}^{2} + Cs + K} ( {T}_{r} - Ds θ ) \\ \frac{θ}{{T}_{r}} = \frac{\frac{1}{{Js}^{2} + Cs + K}}{1 + \frac{1}{{Js}^{2} + Cs + {K}^{2}} Ds} = \frac{1}{{Js}^{2} + ( C + D ) s + K} \qquad Equation ( 6 )$$

If the above equation is set such that the damping amount D is larger while the steering wheel-holding state determination section 13 detects a presence of the body of the vehicle driver around the steering wheel 2 than while it does not, it is possible to suppress the steering wheel from being driven rapidly to reduce a shock applied to the vehicle driver. As a result, as shown in FIG. 16, the amount of the steering angle is smaller when the suppression control is performed (see the broken line) than when the suppression control is not performed (see the solid line).

The damping may be implemented using the rate of temporal change of the steering torque Ts. In this case, a motion equation similar to equation (1) is obtained from the model of the steering mechanism as shown in FIG. 3, and the damping amount D is set based on the motion equation.

The transfer function based on this motion equation is given by the following Equation (7).

$$\frac{{θ}_{2}}{{T}_{a }} = \frac{A}{AB - {K}_{1}^{2}} \\ {T}_{s} = {K}_{1} ( {θ}_{1} - {θ}_{2} ) = \frac{{K}_{1}^{2} - A}{A} {θ}_{2} \qquad Equation ( 7 )$$

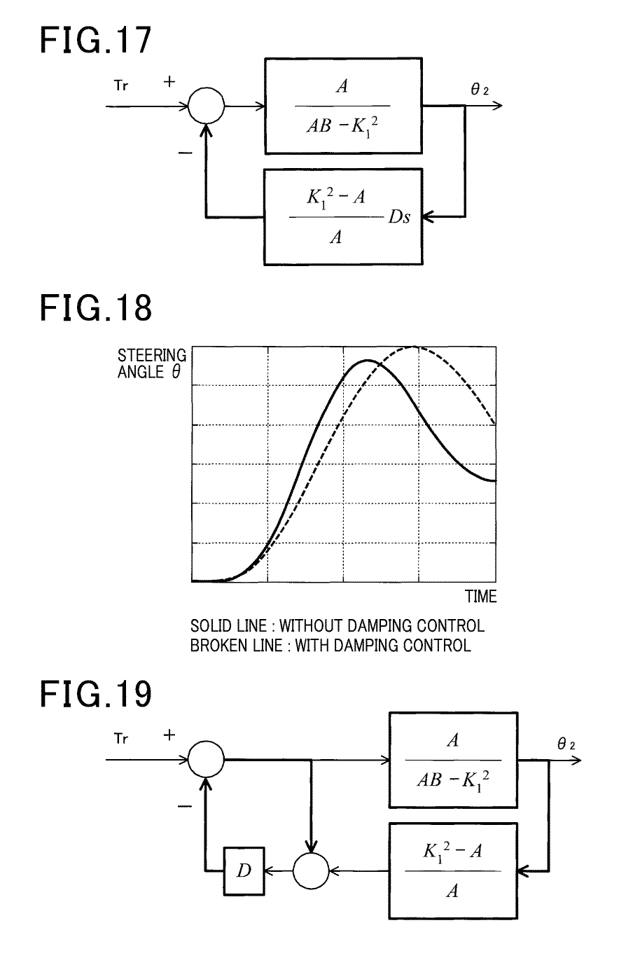

When the damping control amount is D, the whole of the control system of the EPS-ECU 15 can be shown by the block diagram of FIG. 17. The input-output relationship of this control system is given by the following Equation (8).

$$\begin{matrix}\frac{{θ}_{2}}{{T}_{r}} = \frac{\frac{A}{AB - {K}_{1}^{2}}}{1 + \frac{A}{AB - {K}_{1}^{2}} \frac{{K}_{1}^{2} - A}{A} Ds} \\ = \frac{\frac{A}{AB - {K}_{1}^{2}}}{1 + \frac{{K}_{1}^{2} - A}{AB - {K}_{1}^{2}} Ds} \\ = \frac{A}{AB - {K}_{1}^{2} + ( {K}_{1}^{2} - A ) Ds} \\ = \frac{A}{A ( B - Ds ) - {K}_{1}^{2} + {K}_{1}^{2} Ds}\end{matrix} \qquad Equation ( 8 )$$

If the above equation is set such that the damping amount D is larger while the steering wheel-holding state determination section 13 detects a presence of the body of the vehicle driver around the steering wheel 2 than while it does not detect, it is possible to suppress the steering wheel 2 from being driven rapidly to reduce a shock applied to the vehicle driver. As a result, as shown in FIG. 18, the rate of change of the steering angle is smaller when the suppression control is performed (see the broken line) than when the suppression control is not performed (see the solid line).

The damping may be implemented using the road load Ti between the road surface and the tires of the vehicle. In this case, a motion equation similar to equation (1) is obtained from a model of the steering mechanism as shown in FIG. 3, and the damping amount is set based on this motion equation.

The transfer function based on this motion equation is given by the following Equation (9).

$$\frac{{θ}_{2}}{{T}_{a}} = \frac{A}{AB - {K}_{1}^{2}} \\ {T}_{s} = {K}_{1} ( {θ}_{1} - {θ}_{2} ) = \frac{{K}_{1}^{2} - A}{A} {θ}_{2} \\ {T}_{i} = {T}_{a} + {T}_{s} = {T}_{a} + \frac{{K}_{1}^{2} - A}{A} {θ}_{2} \qquad Equation ( 9 )$$

When the damping control amount is D, the whole of the control system of the EPS-ECU 15 can be shown by the block diagram of FIG. 19. The input-output relationship of this control system is given by the following Equation (10).

$$\begin{matrix}{T}_{a} = {T}_{r} - D ( {T}_{a} + \frac{{K}_{1}^{2} - A}{A} {θ}_{2} ) \\ ( 1 + D ) {T}_{a} = {T}_{r} - D \frac{{K}_{1}^{2} - A}{A} {θ}_{2} \\ {T}_{a} = \frac{1}{1 + D} {T}_{r} - \frac{D}{1 + D} \frac{{K}_{1}^{2} - A}{A} {θ}_{2} \\ \begin{matrix}{θ}_{2} = \frac{A}{AB - {K}_{1}^{2}} {T}_{a} \\ = \frac{A}{AB - {K}_{1}^{2}} \{ \frac{1}{1 + D} {T}_{r} - \frac{D}{1 + D} \frac{{K}_{1}^{2} - A}{A} {θ}_{2} \} \\ = \frac{A}{AB - {K}_{1}^{2}} \frac{1}{1 + D} {T}_{r} - \frac{A}{AB - {K}_{1}^{2}} \frac{D}{1 + D} \frac{{K}_{1}^{2} - A}{A} {θ}_{2}\end{matrix} & Equation ( 10 ) \\ ( 1 + \frac{( {K}_{1}^{2} - A ) D}{( AB - {K}_{1}^{2} ) ( 1 + D )} ) {θ}_{2} = \frac{A}{( AB - {K}_{1}^{2} ) ( 1 + D )} {T}_{r} \\ \begin{matrix}\frac{{θ}_{2}}{{T}_{r}} = \frac{A}{( AB - {K}_{1}^{2} ) ( 1 + D ) + ( {K}_{1}^{2} - A ) D} \\ = \frac{A}{AB + ABD - {K}_{1}^{2} - {K}_{1}^{2} D + {K}_{1}^{2} D - AD} \\ = \frac{A}{A \{ ( 1 + D ) B - D \} - {K}_{1}^{2}}\end{matrix} & \end{matrix}$$

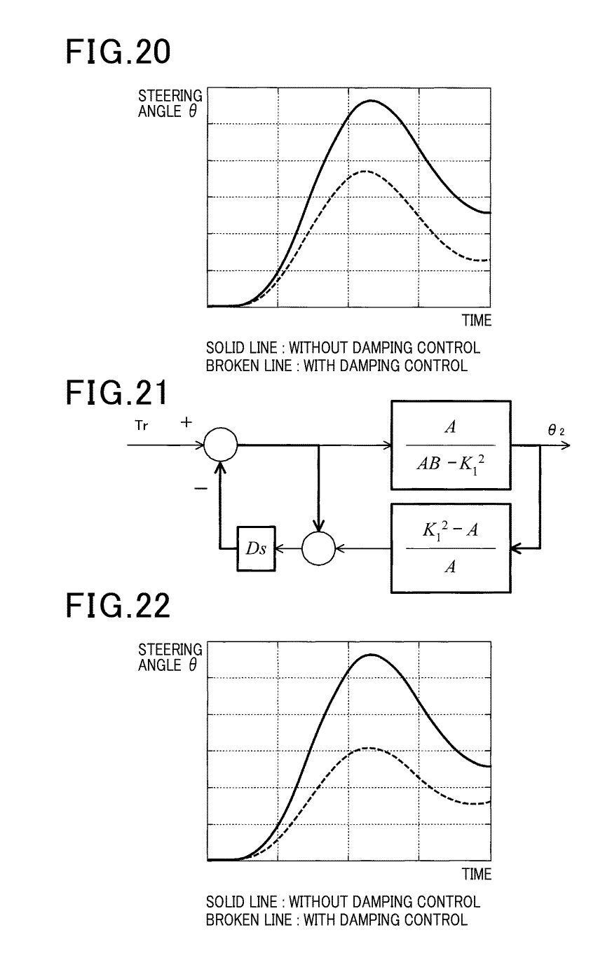

If the above equation is set such that the damping amount D is larger while the steering wheel-holding state determination section 13 detects a presence of the body of the vehicle driver around the steering wheel 2 than while it does not detect the driver, it is possible to suppress the steering wheel 2 from being driven rapidly to reduce a shock applied to the vehicle driver. As a result, as shown in FIG. 20, the amount or the rate of change of the steering angle is smaller when the suppression control is performed (see the broken line) than when the suppression control is not performed (see the solid line).

The damping may be implemented using the rate of change of the road load Ti. In this case, a motion equation similar to equation (1) is obtained from a model of the steering mechanism as shown in FIG. 3, and the damping amount is set based on this motion equation.

The transfer function based of this motion equation is given by the following Equation (11).

$$\frac{{θ}_{2}}{{T}_{a}} = \frac{A}{AB - {K}_{1}^{2}} \\ {T}_{s} = {K}_{1} ( {θ}_{1} - {θ}_{2} ) = \frac{{K}_{1}^{2} - A}{A} {θ}_{2} \\ {T}_{i} = {T}_{a} + {T}_{s} = {T}_{a} + \frac{{K}_{1}^{2} - A}{A} {θ}_{2} \qquad Equation ( 11 )$$

When the damping control amount is D, the whole of the control system of the EPS-ECU 15 can be shown by the block diagram of FIG. 21. The input-output relationship of this control system is given by the following Equation (12).

$$\begin{matrix} {T}_{a} = {T}_{r} - Ds ( {T}_{a} + \frac{{K}_{1}^{2} - A}{A} {θ}_{2} ) \\ ( 1 + Ds ) {T}_{a} = {T}_{r} - Ds \frac{{K}_{1}^{2} - A}{A} {θ}_{2} \\ {T}_{a} = \frac{1}{1 + Ds} {T}_{r} - \frac{Ds}{1 + Ds} \frac{{K}_{1}^{2} - A}{A} {θ}_{2} \\ \begin{matrix}{θ}_{2} = \frac{A}{AB - {K}_{1}^{2}} Ta \\ = \frac{A}{AB - {K}_{1}^{2}} \{ \frac{1}{1 + Ds} {T}_{r} - \frac{Ds}{1 + Ds} \frac{{K}_{1}^{2} - A}{A} {θ}_{2} \} \\ = \frac{A}{AB - {K}_{1}^{2}} \frac{1}{1 + Ds} {T}_{r} - \frac{A}{AB - {K}_{1}^{2}} \frac{Ds}{1 + Ds} \frac{{K}_{1}^{2} - A}{A} {θ}_{2}\end{matrix} & Equation ( 12 ) \\ ( 1 + \frac{( {K}_{1}^{2} - A ) Ds}{( AB - {K}_{1}^{2} ) ( 1 + Ds )} ) {θ}_{2} = \frac{A}{( AB - {K}_{1}^{2} ) ( 1 + Ds )} {T}_{r} \\ \begin{matrix} \frac{{θ}_{2}}{{T}_{r}} = \frac{A}{( AB - {K}_{1}^{2} ) ( 1 + Ds ) + ( {K}_{1}^{2} - A ) Ds} \\ = \frac{A}{AB + ABDs - {K}_{1}^{2} - {K}_{1}^{2} Ds + {K}_{1}^{2} Ds - ADs} \\ = \frac{A}{A \{ ( 1 + Ds ) B - Ds \} - {K}_{1}^{2}}\end{matrix} & \end{matrix}$$

If the above equation is set such that the damping amount D is larger while the steering wheel-holding state determination section 13 detects a presence of the body of the vehicle driver around the steering wheel 2 than while it does not, it is possible to suppress the steering wheel 2 from being driven rapidly, to reduce a shock applied to the vehicle driver. As a result, as shown in FIG. 22, the amount or the rate of the steering angle is smaller when the suppression control is performed (see the broken line) than when the suppression control is not performed (see the solid line).

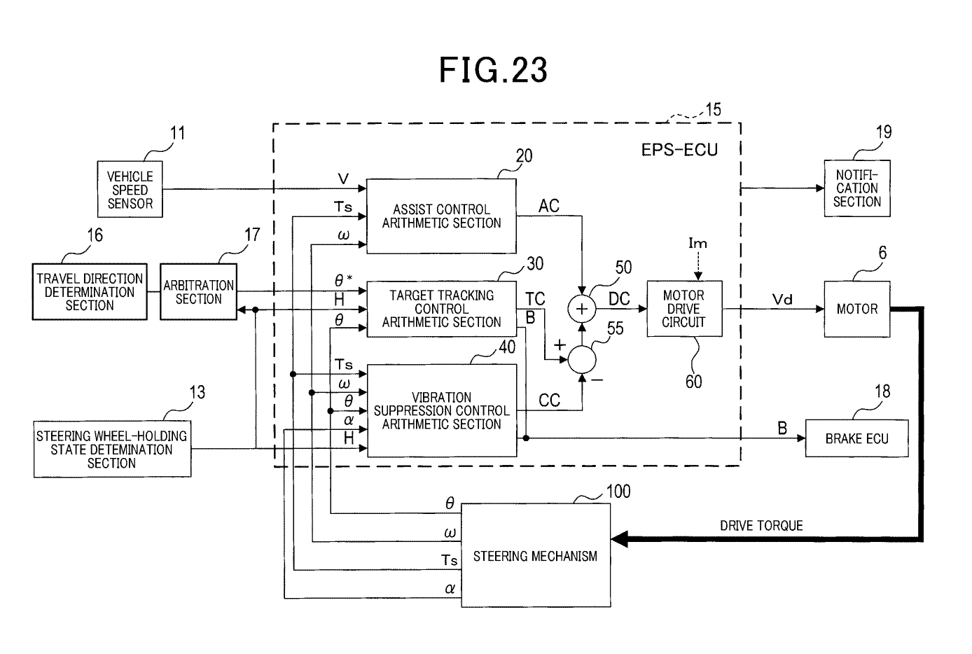

The electric steering systems according to the above described embodiments may be provided with an arbitration section 17 having the structure shown FIG. 23. The arbitration section 17 is disposed on the signal line between the travel direction determination section 16 and the EPS-ECU 15, for example. The arbitration section 17 restricts the driving of the steering wheel 2 when there is an abnormality in the steering wheel-holding state determination section 13. The arbitration section 17 determines that there is an abnormality in the steering wheel-holding state determination section 13 if the signal received from the steering wheel-holding state determination section 13 does not change for over a predetermined time, or if no signal is received from the steering wheel-holding state determination section 13. In this case, the arbitration section 17 restricts the upper limit or the rate of change of the target steering angle θ*.

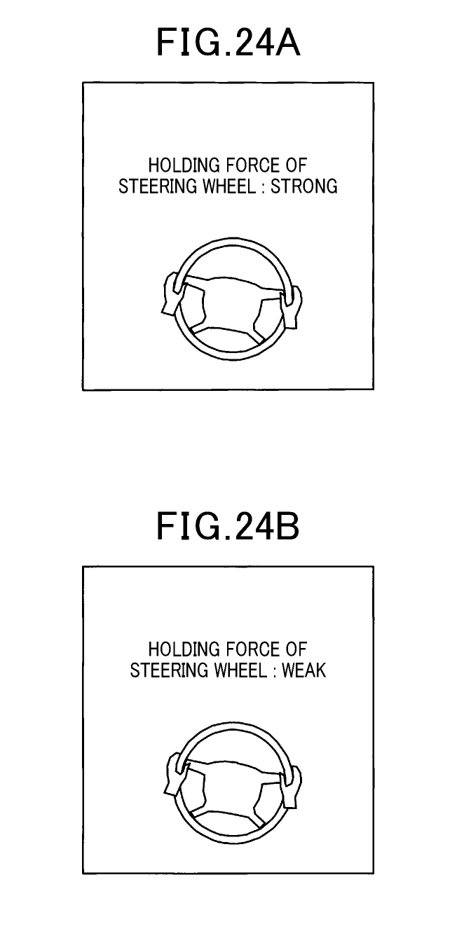

The provision of the arbitration section 17 makes it possible to drive the steering wheel 2 safely even when there is an abnormality in the steering wheel-holding state determination section 13. The electric steering systems according to the above described embodiments may be configured to provide various information depending on the state of detection by the steering wheel-holding state determination section 13 or the state of restriction of the driving of the steering wheel 2. For example, the degree of the holding force applied to the steering wheel 2 by the vehicle driver may be displayed as pictures as shown in FIGS. 24A and 24B.

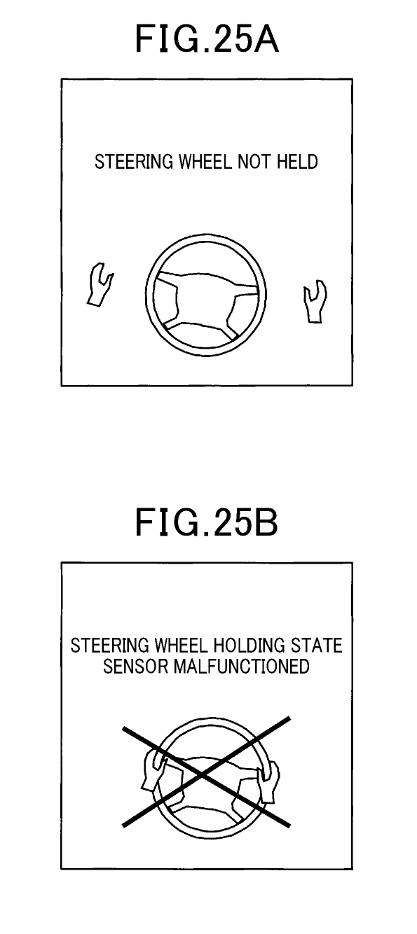

When the steering wheel 2 is not held by the vehicle driver, a picture to encourage the vehicle driver to hold the steering wheel 2 as shown in FIG. 15 may be displayed. When an abnormality is detected in the steering wheel-holding state determination section 13, a picture to inform the vehicle driver of the malfunction as shown in FIG. 25B may be displayed.

These pictures may be displayed reflecting a positional relationship between the steering wheel 2 and a part (palms or arms, for example) of the body of the vehicle driver detected by the steering wheel-holding state determination section 13. In this case, the vehicle driver can confirm whether the detection result of the sensor agrees to the behavior of the vehicle driver.

The reduction gear device 6a may be configured such that its gear ratio is variable depending on the vehicle state such as the vehicle speed. That is, the above described embodiments may include a variable gear ratio steering actuator. In this case, the target tracking control arithmetic section 30 or the vibration suppression control arithmetic section 40 may command the variable gear ratio steering actuator to set the target gear ratio such that the steering drive speed is reduced when the driving of the steering wheel 2 is restricted.

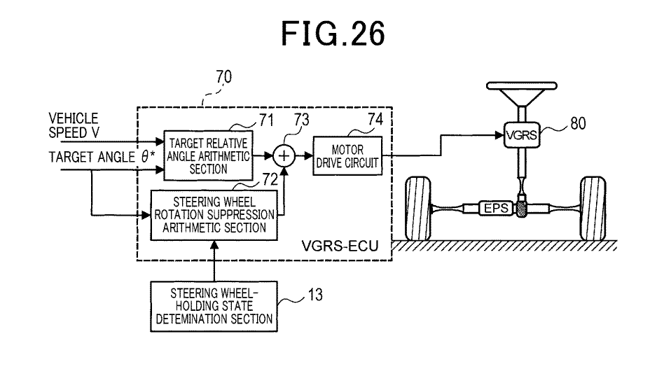

More specifically, the electric steering system may be configured as shown in FIG. 26. This configuration includes a VGRS (Variable Gear Ratio Steering) 80 and a VGRS-ECU 70.

The VGRS-ECU 70 sets the amount of change of the tire steering angle relative to the steering amount (that is, the gear ratio) in accordance with the vehicle speed V and the target steering angle θ*, and output this setting to the VGRS 80. As shown in FIG. 26, the VGRS-ECU 70 includes a CPU and a memory (not shown). This CPU provides the functions of a target relative angle calculation arithmetic section 71, a steering wheel rotation suppression arithmetic section 72, an adder 73 and a motor drive circuit 74.

The target relative angle calculation arithmetic section 71 calculates a target relative angle between the steering wheel and the pinion angle based on the vehicle speed V and the target steering angle θ*. The steering wheel rotation suppression arithmetic section 72 calculates a controlled variable (gear ratio) to suppress the rotation of the steering wheel.

The adder 73 sums the output of the target relative angle calculation arithmetic section 71 and the output of the steering wheel rotation suppression arithmetic section 72, and sends the result of the summation to the motor drive circuit 74. The motor drive circuit 74 generates a command value to set the gear ratio in accordance with the result of the summation, and outputs it to the VGRS 80. The output of the motor drive circuit 74 enables driving a not-shown motor within the VGRS 80 so as to achieve the target relative angle while suppressing the steering wheel from being driven to rotate.

The VGRS 80 drives the motor therein to set the gear ratio in accordance with the command value to set the gear ratio. The electric steering system having such a configuration can reduce a shock applied to the vehicle driver, because the variable gear ratio steering actuator sets the target gear ratio such that the steering drive speed is reduced when the driving of the steering wheel 2 is restricted.

In the above embodiments, the brake actuator complements the steering force when the driving of the steering wheel 2 is restricted. However, an actuator having the function of DRS (Dynamic Rear Steering) or an actuator that performs engine control or motor control may be used instead of the brake actuator.

Correspondence between the embodiments described above and the appended claims:

The electric steering system corresponds to the steering wheel control apparatus. The steering wheel-holding state determination section 13 corresponds to the body position detection section. The target tracking control arithmetic section 30 corresponds to the steering wheel drive section. The target tracking control arithmetic section 30 corresponds to the steering angle driving restriction section. The target tracking control arithmetic section 30, the vibration suppression control arithmetic section 40 and the arbitration section 17 correspond to the steering wheel driving restriction section and the abnormality detection section. The brake ECU 18 corresponds to the complementary section.

The above explained preferred embodiments are exemplary of the invention of the present application which is described solely by the claims appended below. It should be understood that modifications of the preferred embodiments may be made as would occur to one of skill in the art.

What is claimed is:

1. A steering wheel control apparatus for controlling driving of a steering wheel of a vehicle, comprising:
a steering wheel drive section that drives the steering wheel in accordance with a target value;
a shock probability determination section that determines whether the steering wheel may apply a shock to a vehicle driver; and
a steering wheel driving restriction section that restricts driving of the steering wheel by the steering wheel drive section to reduce the shock applied to the vehicle driver when the shock probability determination section determines that the steering wheel may apply the shock to the vehicle driver.

2. The steering wheel control apparatus according to claim 1, further comprising a complementary section that complements a steering force of the steering wheel using a drive section other than the steering wheel drive section when the steering wheel driving restriction section restricts driving of the steering wheel.

3. The steering wheel control apparatus according to claim 1, wherein the steering wheel drive section drives the steering wheel such that a measured value related to the steering wheel approaches the target value, and the steering wheel driving restriction section suppresses the measured value from approaching the target value to restrict driving of the steering wheel.

4. The steering wheel control apparatus according to claim 3, wherein the steering wheel driving restriction section suppresses the measured value from approaching the target value by restricting a set range of the target value, or by restricting a rate or an acceleration of change of the target value when the target value is changed.

5. The steering wheel control apparatus according to claim 3, wherein the steering wheel driving restriction section suppresses the measured value from approaching the target value by changing a value of a deviation between the measured value and the actual value to a smaller value, or by changing the rate or acceleration of change of the target value to a smaller value when the value of the deviation is changed.

6. The steering wheel control apparatus according to claim 3, wherein the steering wheel driving restriction section reduces a responsiveness in causing the measured value to approach the target value to restrict driving of the steering wheel.

7. The steering wheel control apparatus according to claim 3, wherein the steering wheel drive section sets a controlled value for causing the measured value to approach the target value and drives the steering wheel in accordance with the controlled variable, and the steering wheel driving restriction section restricts the controlled variable to suppress the measured value from approaching the target value to restrict driving of the steering wheel.

8. The steering wheel control apparatus according to claim 1, wherein the steering wheel driving restriction section imparts a damping torque to an output of the steering wheel drive section to restrict driving of the steering wheel.

9. The steering wheel control apparatus according to claim 1, wherein the steering wheel driving restriction section sets a target gear ratio of a variable gear ratio steering actuator of the vehicle such that a steering wheel drive speed is reduced.

10. The steering wheel control apparatus according to claim 1, wherein, the shock probability determination section includes a body position detection section that detects a position of a body of the vehicle driver around the steering wheel.

11. The steering wheel control apparatus according to claim 1, wherein, the body position detection section detects a holding state of the steering wheel by the vehicle driver.

12. The steering wheel control apparatus according to claim 1, further comprising a notification section that informs the vehicle driver of an operation state of the steering wheel driving restriction section.

13. The steering wheel control apparatus according to claim 1, further comprising an abnormality detection section for detecting an abnormality in the shock probability determination section,
the steering wheel driving restriction section being configured to restrict driving of the steering wheel when the abnormality detection section detects the abnormality in the shock probability determination section.
